(19) United States
(12) Patent Application Publication
(10) Pub. No.: US 2003/0214775 A1
(43) Pub. Date: Nov. 20, 2003

(54) Portal site server system, portal site method and computer-readable storage medium

(75) Inventors: Shigeki Fukuta, Kawasaki (JP); Takashi Nishigaya, Yokohama (JP); Masanobu Yuhara, Kawasaki (JP); Yasuhide Matsumoto, Kawasaki (JP); Tatsuro Matsumoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/418,139

(22) Filed: Apr. 18, 2003

(30) Foreign Application Priority Data
May 15, 2002 (JP) 2002-140213

(51) Int. Cl. H02B 1/00

(52) U.S. Cl. 361/220

(57) ABSTRACT

A portal site server system provides services of service systems to user terminals of users via at least one network. The portal site server system includes a user profile registering at least communication methods to the users, a communication priority table registering a priority order of the communication methods, a mechanism for making an inquiry to a specific user by a communication method which has a highest priority and is selected from the communication methods registered in the user profile depending on the communication priority table, when a service request is received from the specific user and an inquiry to the specific user is required, and a mechanism for updating the user profile based on information received from the specific user in response to the inquiry.

### BACKGROUND OF THE INVENTION

This application claims the benefit of a Japanese Patent Application No.2002-140213 filed May 15, 2002, in the Japanese Patent Office, the disclosure of which is hereby incorporated by reference.

1. Field of the Invention

The present invention generally relates to portal site server systems, portal site methods and computer-readable storage media, and more particularly to a portal site server system which provides services to a plurality of user terminals via a network, a portal site method usable by such a portal site server system, and a computer-readable storage medium which stores a program for causing a computer to employ such a portal site method.

2. Description of the Related Art

Conventionally, a so-called portal service introduces various kinds of services provided on a network such as the Internet. The various kinds of services may include ticket services, hotel reservation services, municipal office services and the like. The portal service displays a list of services to the user, and the user can receive the various services listed by selecting the desired service and connecting to a server which provides the selected desired service.

Hence, in order to receive the desired service, the user must carry out a series of operations which include connecting to the portal service, selecting the desired service from the list of services displayed by the portal service, and connecting to the server which provides the selected desired service, so as to receive the selected desired service from the server. For this reason, there is a problem in that the user must carry out a troublesome operation of inputting the same user information, such as the user name and address, every time a connection is made to a different server which provides a different service.

It is conceivable to register the user information in a portal service server which provides the portal service. However, if the portal service server notifies the user information to the various servers which provide various services, there is a problem in that privacy and security of the user information cannot be secured.

Furthermore, there is a problem in that the user cannot connect to the server which provides the desired service and receive a response from the server in real-time. In addition, in order for the user to receive a response later from the server after a retrieval or search is completed, there is a problem in that an address of the user such as an electronic mail (e-mail) address must be registered in advance in the server, thereby requiring a high cost to manage information related to the addresses of all of the users by the various servers which provide the various services.

### SUMMARY OF THE INVENTION

Accordingly, it is a general object of the present invention to provide a novel and useful portal site server system, portal site method and computer-readable storage medium, in which the problems described above are eliminated.

Another and more specific object of the present invention is to provide a portal site server systems, a portal site method and a computer-readable storage medium, which can simplify an input operation required by the user for receiving a plurality of services and can secure privacy and security of the user information.

Still another object of the present invention is to provide a portal site server system providing services of service systems to user terminals of users via at least one network, comprising a user profile registering at least communication methods to the users; a communication priority table registering a priority order of the communication methods; means for making an inquiry to a specific user by a communication method which has a highest priority and is selected from the communication methods registered in the user profile depending on the communication priority table, when a service request is received from the specific user and an inquiry to the specific user is required; and means for updating the user profile based on information received from the specific user in response to the inquiry. According to the portal site server system of the present invention, it is possible to communicate with the user by an optimum communication method, simplify an input operation required by the user for receiving a plurality of services, and secure privacy and security of the user information.

A further object of the present invention is to provide a portal site method for providing services of service systems to user terminals of users via at least one network, comprising preparing a user profile which registers at least communication methods to the users, and a communication priority table which registers a priority order of the communication methods; making an inquiry to a specific user by a communication method which has a highest priority and is selected from the communication methods registered in the user profile depending on the communication priority table, when a service request is received from the specific user and an inquiry to the specific user is required; and updating the user profile based on information received from the specific user in response to the inquiry. According to the portal site method of the present invention, it is possible to communicate with the user by an optimum communication method, simplify an input operation required by the user for receiving a plurality of services, and secure privacy and security of the user information.

Another object of the present invention is to provide a computer-readable storage medium which stores a program for causing a computer to provide services of service systems to user terminals of users via at least one network, where the program comprises a procedure causing the computer to prepare a user profile which registers at least communication methods to the users, and a communication priority table which registers a priority order of the communication methods; a procedure causing the computer to make an inquiry to a specific user by a communication method which has a highest priority and is selected from the communication methods registered in the user profile depending on the communication priority table, when a service request is received from the specific user and an inquiry to the specific user is required; and a procedure causing the computer to update the user profile based on information received from the specific user in response to the inquiry. According to the computer-readable storage medium of the present invention, it is possible to communicate with the user by an optimum communication method, simplify an input operation required by the user for receiving a plurality of services, and secure privacy and security of the user information.

Still another object of the present invention is to provide a portal site server system providing services of service systems to user terminals of users via at least one network, comprising a user profile registering at least communication methods to the users; a communication priority table registering a priority order of the communication methods; and a communication method selecting unit selecting one of the communication methods registered in the user profile and having a highest priority, according to the communication priority table, when a service request from a specific user is received and an inquiry to the specific user is required. According to the portal site server system of the present invention, it is possible to communicate with the user by an optimum communication method, simplify an input operation required by the user for receiving a plurality of services, and secure privacy and security of the user information.

A further object of the present invention is to provide a portal site method for providing services of service systems to user terminals of users via at least one network, comprising preparing a user profile registering at least communication methods to the users, and a communication priority table registering a priority order of the communication methods; and selecting one of the communication methods registered in the user profile and having a highest priority, according to the communication priority table, when a service request from a specific user is received and an inquiry to the specific user is required. According to the portal site method of the present invention, it is possible to communicate with the user by an optimum communication method, simplify an input operation required by the user for receiving a plurality of services, and secure privacy and security of the user information.

Another object of the present invention is to provide a computer-readable storage medium which stores a program for causing a computer to provide services of service systems to user terminals of users via at least one network, where the program comprises a procedure causing the computer to prepare a user profile registering at least communication methods to the users, and a communication priority table registering a priority order of the communication methods; and a procedure causing the computer to select one of the communication methods registered in the user profile and having a highest priority, according to the communication priority table, when a service request from a specific user is received and an inquiry to the specific user is required. According to the computer-readable storage medium of the present invention, it is possible to communicate with the user by an optimum communication method, simplify an input operation required by the user for receiving a plurality of services, and secure privacy and security of the user information.

Other objects and further features of the present invention will be apparent from the following detailed description when read in conjunction with the accompanying drawings.

### BRIEF DESCRIPTION OF THE DRAWINGS

FIG. 1 is a system block diagram showing an embodiment of a portal site server system according to the present invention;

FIG. 2 is a flow chart for explaining an operation of the portal site server system;

FIG. 3 is a flow chart for explaining another operation of the portal site server system;

FIG. 4 is a diagram showing a user profile;

FIG. 5 is a diagram showing a communication priority table;

FIG. 6 is a diagram showing a service profile;

FIG. 7 is a diagram showing a content database;

FIG. 8 is a diagram showing a first display on a screen of a user terminal;

FIG. 9 is a diagram showing a second display on the screen of the user terminal;

FIG. 10 is a diagram showing a third display on the screen of the user terminal;

FIG. 11 is a diagram showing a fourth display on the screen of the user terminal; and

FIG. 12 is a diagram showing a fifth display on the screen of the user terminal.

### DESCRIPTION OF THE PREFERRED EMBODIMENTS

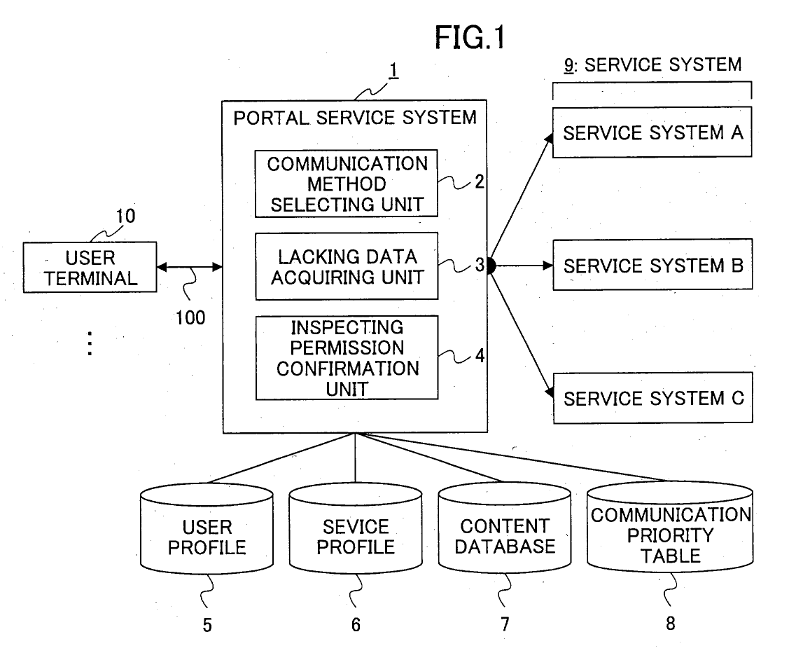

FIG. 1 is a system block diagram showing an embodiment of a portal site server system according to the present invention. This embodiment of the portal site server system employs an embodiment of a portal site method according to the present invention and an embodiment of a computer-readable storage medium according to the present invention.

A portal service system 1 shown in FIG. 1 provides services by a plurality of service systems 9 with respect to a plurality of user terminals 10. The portal service system 1 includes a communication method selecting unit 2, a lacking data acquiring unit 3, an inspecting permission confirmation unit 4, a user profile 5, a service profile 6, a content database (DB) 7, and a communication priority table 8. The portal service system 1 forms this embodiment of the portal site server system. The user terminals 10 may be connected to the portal service system 1 via one or a plurality of networks 100. The portal server system 1 may be connected to the service systems 9 via one or a plurality of networks.

The communication method selecting unit 2 selects a communication method having a highest priority. The lacking data acquiring unit 3 acquires lacking data related to a user, and stores the acquired lacking data in the user profile 5.

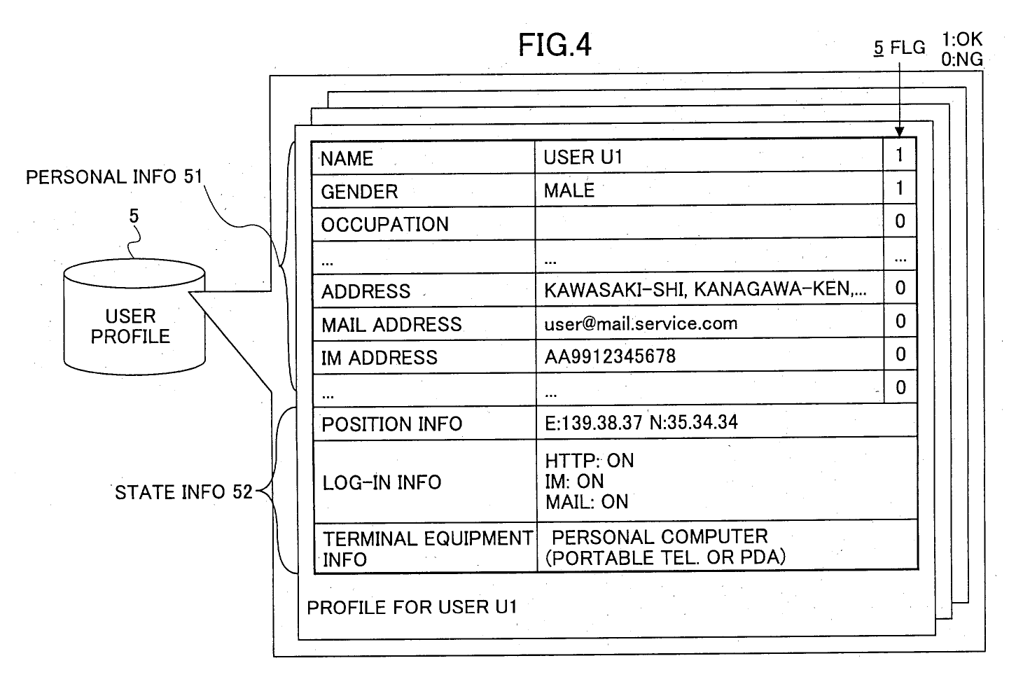

The inspecting permission confirmation unit 4 permits inspection or confirms inspecting permission when providing information related to the user, that is, user information stored in the user profile 5, to the service system 9. The user profile 5 registers user information related to a plurality of users, including personal information 51 related to the users, and state information 52 related to the communication methods, as will be described later in conjunction with FIG. 4.

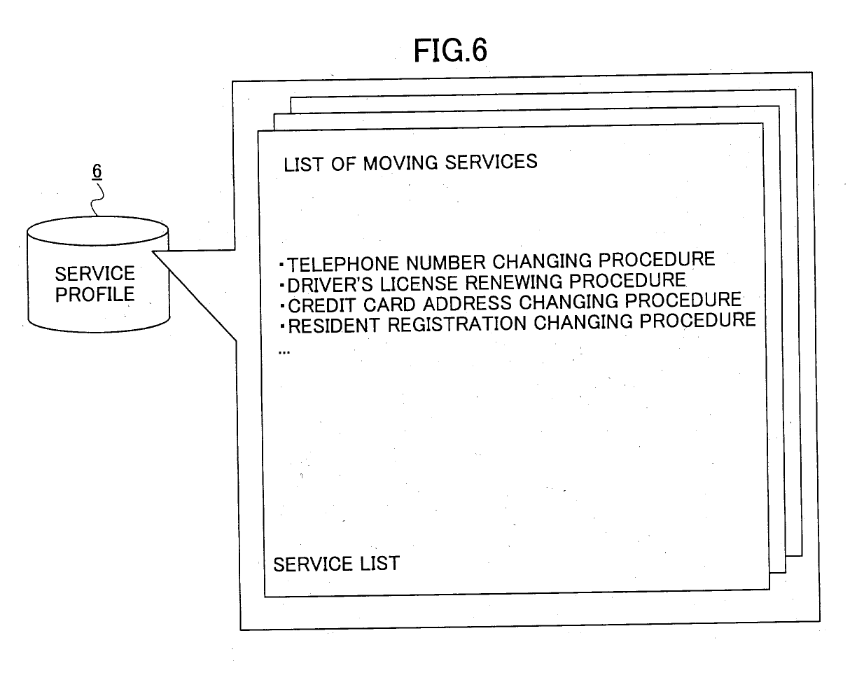

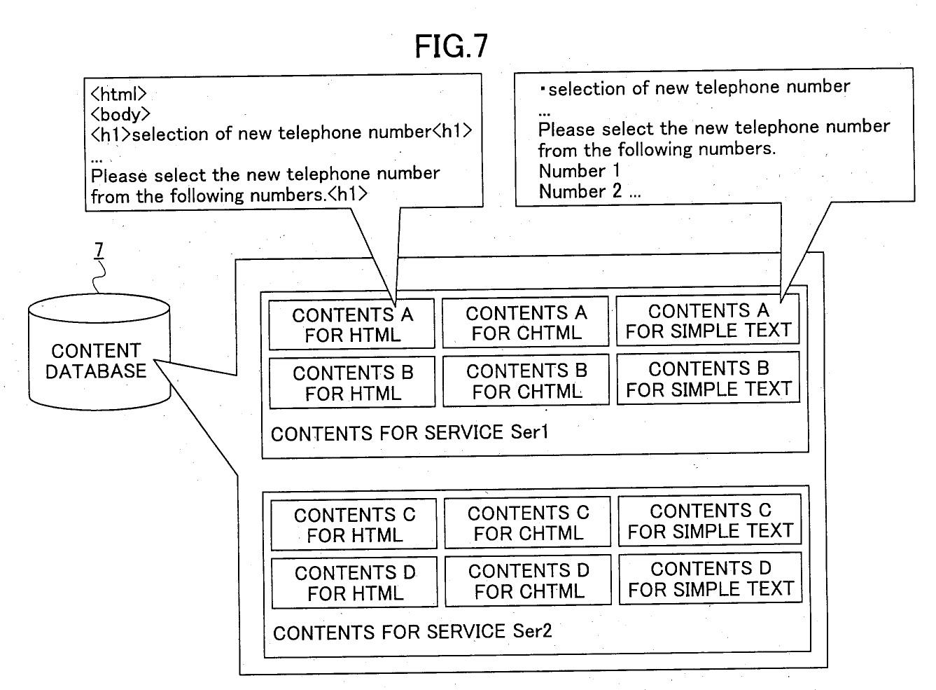

The service profile 6 stores a list of related services, as will be described later in conjunction with FIG. 6. The content database 7 registers contents for each of the services, that is, contents for different communication methods, as will be described later in conjunction with FIG. 7. The communication priority table 8 registers priority information (priority order) related to the communication methods.

The portal service system 1 may be realized by a computer (or server) having a known structure which includes a processor such as a CPU and a storage section. The processor realizes the functions of the communication method selecting unit 2, the lacking data acquiring unit 3 and the inspecting permission confirmation unit 4. The storage section may be made up of one or a plurality of storage units, storage devices and/or storage media. This storage section stores the user profile 5, the service profile 6, the content database 7 and the communication priority table 8.

The storage section also stores computer programs which are executed by the processor of the computer. The computer programs includes a program for causing the computer to provide services to a plurality of users (user terminals 10) via one or a plurality of networks by employing the portal site method according to the present invention. The embodiment of the computer-readable storage medium stores such a program. A recording medium forming the computer-readable storage medium may be any type of media capable of storing the program in a computer-readable manner, including optical, magnetic and magneto-optical recording media and semiconductor memory devices.

Each service system 9 may be formed by a computer (or server) having a known structure including a processor and a storage section, and provides various services to the user in response to requests from the portal service system 1. Each user terminal 10 is used by an arbitrary user, and may be formed by a personal computer, portable terminal, portable telephone (cellular phone), PDA or the like having a known structure including a processor and a storage section.

The portal site server system basically operates as follows. That is, the communication method selecting unit 2 of the portal service system 1 selects one of the communication methods registered in the user profile 5 and having a highest priority, according to the communication priority table 8, when a service request from a user is received and it becomes necessary to make an inquiry to this user. The lacking data acquiring unit 3 makes the inquiry to the user by the communication method selected by the communication method selecting unit 2, and updates the user profile 5 based on information received from the user in response to the inquiry.

In this state, when the user information related to a specific user is requested from the service system 9, the requested user information related to the specific user is read from the user profile 5 which registers the user information related to the users, and the requested user information which is read from the user profile 5 is notified to the service system 9.

In addition, inspecting permission information, indicating inspecting permission with respect to the user information related to each user registered in the user profile 5, is registered in the user profile 5. When the inspecting permission information indicating no inspecting permission is registered in the user profile 5 for a specific user but confirmation of the inspecting permission is received from the specific user in response to an inquiry, the inspecting permission confirmation unit 4 notifies the user information which is related to the specific user and is registered in the user profile 5 to the service system 9.

When a notification is made to the user by a communication method, contents of the notification are converted depending on the communication method before being sent.

A list of related services registered in the service profile 6 is displayed to the user. When the user selects one of the related services from the displayed list, a procedure is requested to the service system 9 which provides the service selected by the user.

Therefore, when a service request is made from a user and it becomes necessary to make an inquiry to the user, the inquiry is made according to a communication method having a highest priority among the registered communication method, and the user profile 5 is updated based on the information received from the user in response to the inquiry. In addition, if necessary, the inspecting permission confirmation unit 4 notifies the user information which is related to the user and is registered in the user profile 5 to the service system 9 which provides the service requested by the user. As a result, it is possible to make inquiries to the user by an optimum communication method, simplify an input operation required by the user for receiving the services, and secure privacy and security of the user information related to the user.

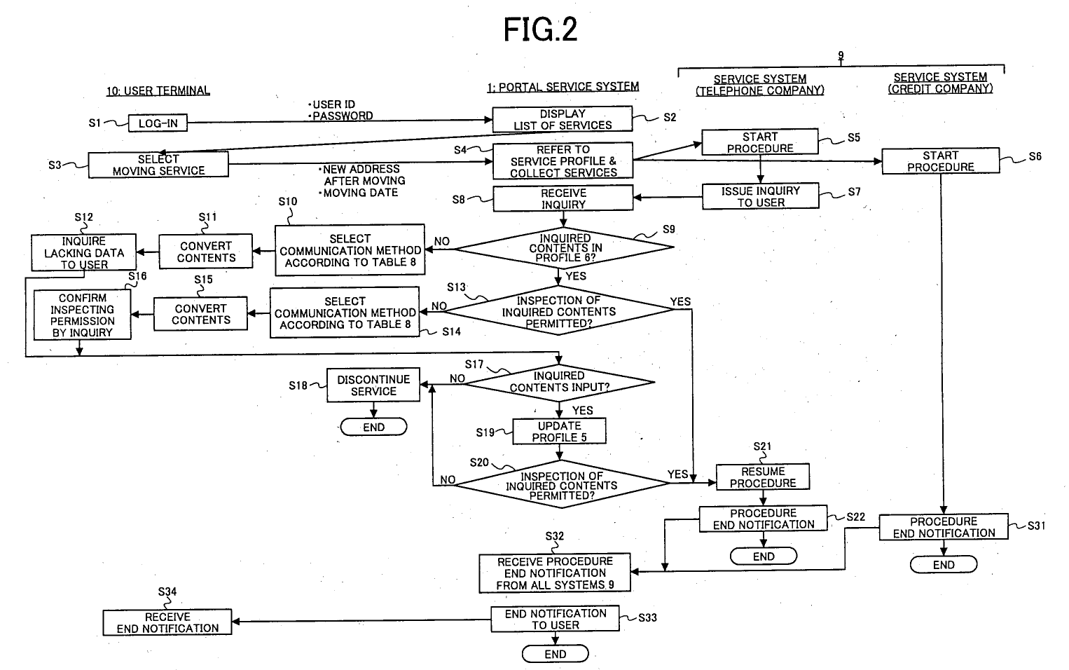

Next, a description will be given of an operation of the portal site server system shown in FIG. 1, by referring to FIG. 2. FIG. 2 is a flow chart for explaining the operation of the portal site server system. More particularly, FIG. 2 shows the operation of the user terminal 10, the portal service system 1 and the service system 9 shown in FIG. 1.

In FIG. 2, the user terminal 10 makes a log-in, in a step S1. This log-in is made when a user operates the user terminal 10 and connects to the portal service system 1 via the network 100, so as to access a home page of the portal service system 1. When the user inputs information such as a user ID and a password on a log-in screen which is displayed on the user terminal 10 when the home page of the portal service system 1 is accessed, the input information is sent to the portal service system 1 via the network 100. The portal service system 1 checks the input information from the user terminal 10, and starts a step S2 if the input information indicates a legitimate user, for example. On the other hand, if the input information does not indicate a legitimate user, for example, the log-in screen may be displayed on the user terminal 10 to urge the user to make the log-in again.

The portal service system 1 downloads and displays a list of services to the user terminal 10, in the step S2.

The user selects a desired service from the list of services displayed on the screen of the user terminal 10, in a step S3. For example, the user selects a moving service, and inputs a new address to which the user is moving, a moving date and the like on the screen of the user terminal 10. The information related to the moving and input by the user is sent to the portal service system 1.

The portal service system 1 refers to the user profile 5 and collects the services, by checking whether or not the input data necessary for the services are included in the user profile 5 when judging whether or not to utilize the services, in a step S4. For example, the service profile 6 includes a plurality of lists of related services, including a list of moving services, as shown in FIG. 6 which will be described later. The list of moving services shown in FIG. 6 includes a telephone number changing procedure, a driver's license renewing procedure, a credit card address changing procedure, a resident registration changing procedure and the like. Hence, in this case, the step S4 collects the services (procedures) required by the user for the moving, by referring to the user profile 5 shown in FIG. 4.

The information required by the services (procedures) collected by the step S4 is notified to the corresponding service systems 9 which provide the service (procedure), and the services (procedures) are requested to the corresponding service systems 9, in steps S5 and S6. For example, one service system 9 of a telephone company starts the telephone number changing procedure in the step S5, and another service system 9 of a credit card company starts the credit card address changing procedure in the step S6. In this particular case, the credit card address changing service is continued until the credit card address changing service ends in a step S31 which will be described later.

The service system 9 issues an inquiry to the user, in a step S7. This inquiry to the user is sent to the portal service system 1. For example, the user may request the telephone number changing service to the service system 9 of the telephone company, and the service system 9 may provide three candidate telephone numbers from which the user may select the new telephone number. In such a case, it is necessary for the service system 9 of the telephone company to make an inquiry to the user to inquire which one of the three candidate telephone numbers the user wishes to select as the new telephone numbers.

The inquiry to the user issued by the service system 9 in the step S7 is received by the portal service system 1, in a step S8.

The portal service system 1 decides whether or not the inquired contents of the inquiry received in the step S8 are stored in the user profile 5 shown in FIG. 4 which will be described later. The process advances to a step S13 if the decision result in the step S9 is YES, but the process advances to a step S10 if the decision result in the step S9 is NO.

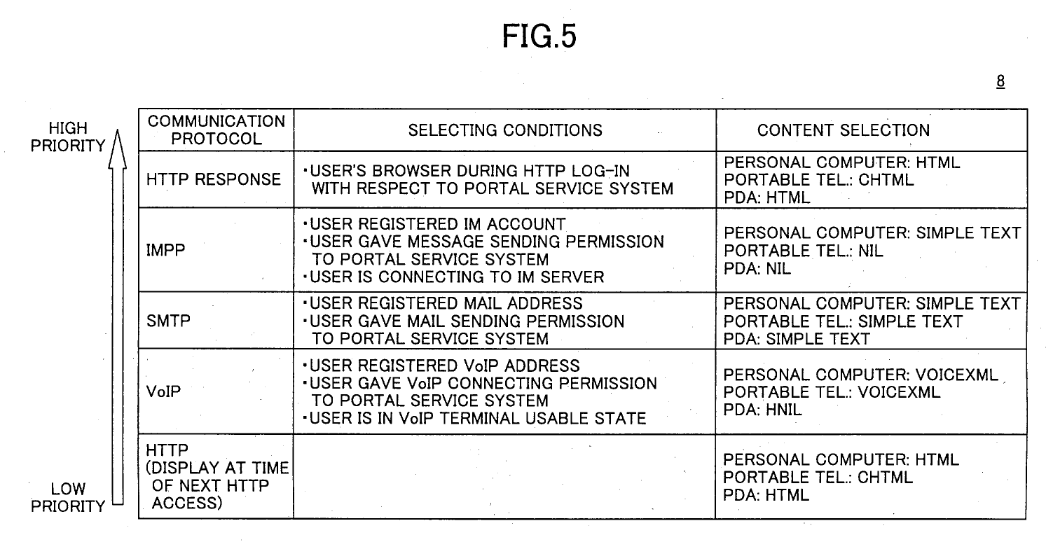

The portal service system 1 selects a communication method according to the communication priority table 8 shown in FIG. 5 which will be described later, in the step S10, based on the state information 52 of the communication method stored in the user profile 5 shown in FIG. 4 which will be described later and corresponding to the user to which the inquiry is to be made. More particularly, the step S10 selects the communication method having a highest priority, according to the communication priority table 8 shown in FIG. 5.

The portal service system 1 converts the inquired contents, in a step S11, so as to conform to the communication method which has the highest priority and is selected by the step S10, using the content database 7 shown in FIG. 7 which will be described later. In other words, the step S11 converts the inquired contents into contents communicatable by the selected communication method.

The portal service system 1 makes an inquiry for lacking data to the user, in a step S12, based on the converted inquired contents. More particularly, the step S12 sends the converted contents obtained in the step S11 to the user terminal 10 by the communication method selected by the step S10. When the user responds to the inquiry by operating the user terminal 10, the process advances to a step S17.

The portal server system 1 decides whether or not the inspection of the inquired contents is permitted, in the step S13, based on the user profile 5 shown in FIG. 4. If the decision result in the step S13 is YES, the portal server system 1 reads the inquired contents from the user profile 5 shown in FIG. 4, and notifies the inquired contents to the service system 9 of the telephone company, that is, the source of the inquiry. The service system 9 of the telephone company resumes the telephone number changing service in a step S21, and the telephone number changing service is continued until the telephone number changing service ends in a step S22 which will be described later.

On the other hand, if the decision result in the step S13 is NO, the process advances to a step S14 in order to make an inquiry to the user.

The portal service system 1 selects a communication method according to the communication priority table 8 shown in FIG. 5 which will be described later, in the step S14, based on the state information 52 of the communication method stored in the user profile 5 shown in FIG. 4 which will be described later and corresponding to the user to which the inquiry is to be made. More particularly, the step S14 selects the communication method having a highest priority, according to the communication priority table 8 shown in FIG. 5, similarly to the step S10 described above.

The portal service system 1 converts the inquired contents, in a step S15, so as to conform to the communication method which has the highest priority and is selected by the step S14, using the content database 7 shown in FIG. 7 which will be described later. In other words, the step S15 converts the inquired contents into contents communicatable by the selected communication method, similarly to the step S11 described above.

The portal service system 1 makes an inquiry for confirming the inspection permission to the user, in a step S16. When the user responds to the inquiry by operating the user terminal 10, information related to the inspection permission and the like is sent to the portal service system 1, and the process advances to the step S17.

The portal service system 1 decides whether or not the inquired contents are input and received from the user terminal 10, in the step S17. In the case where the step S17 is carried out after the step S12, the inquired contents are the lacking data received from the user terminal 10. In the case where the step S17 is carried out after the step S16, the inquired contents are the information related to the inspection permission and the like received from the user terminal 10. If the decision result in the step S17 is YES, the portal service system 1 updates the user profile 5 shown in FIG. 5 in a step S19, and the process advances to a step S20. On the other hand, if the decision result in the step S17 is NO, the portal service system 1 discontinues the service (procedure) in a step S18 because the inquired contents are-not received, and the process of the portal service system 1 ends.

The portal service system 1 decides whether or not the inspection of the inquired contents is permitted, in the step S20. If the decision result in the step S20 is YES, the portal server system 1 notifies the inquired contents to the service system 9 of the telephone company, that is, the source of the inquiry. The service system 9 of the telephone company resumes the telephone number changing service (procedure) in the step S21, and the telephone number changing service is continued until the telephone number changing service ends in the step S22 which will be described later. On the other hand, if the decision result in the step S20 is NO, the portal service system 1 discontinues the service (procedure) in the step S18 because the inquired contents are not received, and the process of the portal service system 1 ends.

In each of the steps S22 and S31, the corresponding service system 9 makes a service (procedure) end notification with respect to the portal service system, and the process of the corresponding service system 9 ends.

The portal service system 1 receives the service (procedure) end notification from all of the service systems 9, in a step S32. Then, the portal service system 1 makes an end notification to the user, in a step S33, and the process of the portal service system 1 ends.

Finally, the user terminal 10 receives the end notification from the portal service system 1, in a step S34.

In FIG. 2, at least the steps S10 and S14 are carried out by the communication method selecting unit 2, at least the step S12 is carried out by the lacking data acquiring unit 3, and at least the step S13 is carried out by the inspecting permission confirmation unit 4.

Therefore, when the moving service is selected in the step S3, for example, the portal service system 1 refers to the related services of the service profile 6 shown in FIG. 6 and extracts (or collects) the required services by referring to the user profile 5 shown in FIG. 4 of the concerned user. The extracted service (procedure) is requested to the corresponding service system 9 which provides the extracted service, by notifying to the service system 9 the user information of the concerned user the inspection of which is permitted. If the service system 9 needs to make an inquiry to the concerned user, this is notified to the portal service system 1. If the inquired contents are registered in the user profile 5 and the inspection of the registered contents is permitted, the inquired contents are read from the user profile 5 and notified to the service system 9 so that the service may be continued. On the other hand, if the inquired contents are registered in the user profile 5 but the inspection of the registered contents is not permitted or, the inquired contents are not registered in the user profile 5, the inquired contents, that is, the lacking data, are inquired to the user by an optimum communication method. When the user sends the confirmation of the inspecting permission or the lacking data from the user terminal 10 in response to the inquiry, the inspecting permission or the lacking data are used to update the user profile 5, and the inquired contents are notified to the service system 9 so that the service may be continued. Accordingly, it is possible to make inquiries to the user by an optimum communication method, simplify an input operation required by the user for receiving the services, and secure privacy and security of the user information related to the user.

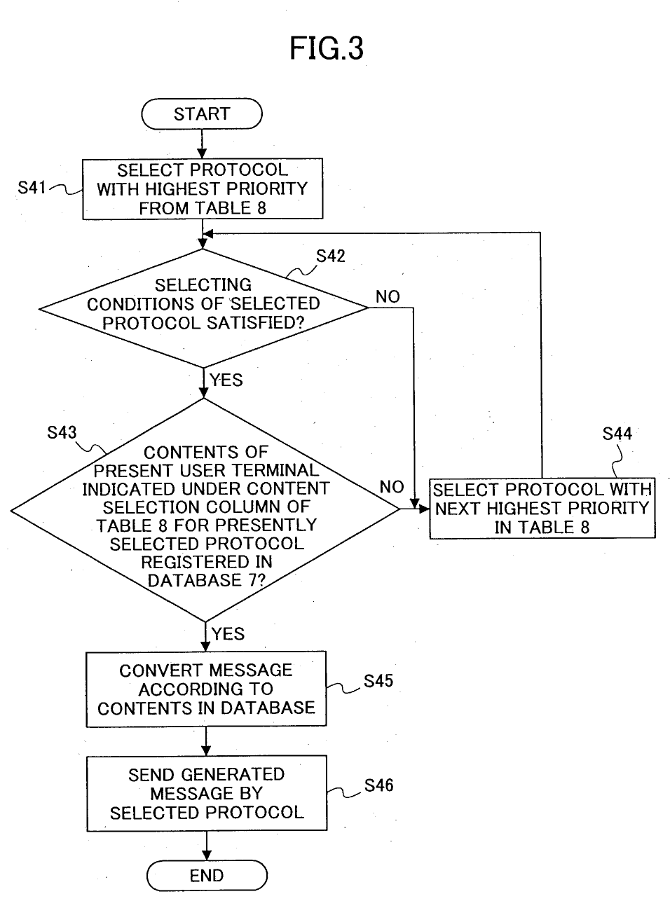

FIG. 3 is a flow chart for explaining another operation of the portal site server system shown in FIG. 1.

In FIG. 3, a step S41 selects the communication method, that is, a communication protocol, having the highest priority from the communication priority table 8 shown in FIG. 5. In this particular case, the step S41 selects the HTTP response as the communication protocol having the highest priority in the communication priority table 8 shown in FIG. 5.

A step S42 decides whether or not selecting conditions of the selected communication protocol are satisfied. In this particular case, the step S42 decides whether or not the selecting condition “a browser of the user is in a HTTP log-in state with respect to the portal service system 1” is satisfied for the selected communication protocol “HTTP response”. The process advances to a step S43 if the decision result in the step S42 is YES. On the other hand, if the decision result in the step S42 is NO, a step S44 selects a communication protocol having the next highest priority to the presently selected communication protocol in the communication priority table 8 shown in FIG. 5, and the process returns to the step S42.

The step S43 decides whether or not the contents of the present user terminal 10 indicated under a content selection column of the communication priority table 8 shown in FIG. 5 for the presently selected communication protocol are registered in the content database 7 shown in FIG. 7. For example, the step S43 decides whether or not the contents “personal computer: HTML, portable telephone: CHTML, PDA: HTML” indicated under the content selection column of the communication priority table 8 for the presently selected communication protocol “HTTP response” are registered in the content database 7. If the decision result in the step S43 is YES, a step S45 converts a message according to the contents registered in the content database 7. Further, a step S46 sends the generated message to the user terminal 10 by the selected communication protocol, and the process ends. On the other hand, if the decision result in the step S43 is NO, the step S44 selects a communication protocol having the next highest priority to the presently selected communication protocol in the communication priority table 8 shown in FIG. 5, because the contents are not registered in the content database 7, and the process returns to the step S42.

Therefore, when the portal service system 1 makes an inquiry to the user, the communication protocol to be used for the inquiry is selected from the communication protocols set in the communication priority table 8 shown in FIG. 5 and having the highest priority. If the selecting conditions of the selected communication protocol in the communication priority table 8 are satisfied, a decision is made to determine whether or not the contents of the present user terminal 10 are registered in the content database 7 shown in FIG. 7. If the contents are registered in the content database 7, a message is converted according to the registered contents, and the converted message is sent to the user terminal 10 of the user by the selected communication protocol. Hence, the selecting conditions can be checked in order starting from the communication protocol having the highest priority, and the inquiry to the user terminal 10 can be made by converting the message using an optimum communication protocol, that is, an optimum communication method.

FIG. 4 is a diagram showing the user profile 5. The user profile 5 includes the personal information 51, the state information 52 and the like for each of the users, which are registered and/or updated. For the sake of convenience, FIG. 4 shows the profile for a user U1.

The personal information 51 includes elements such as a name, gender, occupation, address, mail (e-mail) address and IM address. The name is “user U1”, the gender is “male”, the address is “Kawasaki-Shi, Kanagawa-Ken, . . . ”, the mail address is “user1@mail.service.com”, and the IM address is “aa9912345678” in this particular case. An inspecting permission flag FLG is provided with respect to each element of the personal information 51. The inspection of the element is permitted if the inspecting permission flag FLG is “1”, and the inspection of the element is not prohibited if the inspecting permission flag FLG is “0”. Hence, the element of the personal information 51 is automatically notified to the service system 9 when inquired therefrom if the corresponding inspecting permission flag FLG is “1”. But when the corresponding inspecting permission flag FLG of the element of the personal information 51 is “0”, this element is notified to the service system 9 only if the user confirms the inspecting permission in response to an inquiry.

The inspecting permission flag FLG may be set arbitrarily with respect to each element of the personal information 51. For example, the inspecting permission flag FLG may be set in common for each of the elements of the personal information 51 of the same user U1, for example. In addition, the inspecting permission flag FLG may be provided in common with respect to all of the service systems 9. Moreover, the inspecting permission flag FLG may include additional bits to indicate that the inspection of the corresponding element of the personal information 51 is permitted with respect to first predetermined service systems 9 but simultaneously prohibited for second predetermined service systems 9 which are different from the first predetermined service systems 9. Furthermore, the inspecting permission flag FLG may permit the inspection of the corresponding element with respect to a service system 9 having an authentication certificate managed by VeriSign, Inc., for example, and prohibit the inspection of the corresponding element with respect to a service system 9 having no authentication certificate by VeriSign, Inc.

The state information 52 includes elements such as position information, log-in information and terminal equipment information. The position information is “E:139.38.37 N:35.34.34” in this particular case, and indicates the east longitude, the latitude or the like of the present position. The log-in information includes HTTP, IM and Mail which may be ON or OFF, and indicates the state of the communication method when the log-in is made. In this particular case, the HTTP is OFF, the IM is ON and the Mail is ON. The terminal equipment information includes personal computer, portable telephone, PDA and the like. In this particular case, the terminal equipment information is “personal computer”, indicating that the user terminal 10 of the user U1 is a personal computer.

FIG. 5 is a diagram showing the communication priority table 8. The communication priority table 8 includes the communication protocol, the selecting conditions, the content selection and the like, which are registered in order of priority. The priority is higher for the communication protocols indicated in the upper rows, and the priority is lower for the communication protocols indicated in the lower rows in FIG. 5.

In the communication priority table 8, the communication protocol indicates the communication protocol used for the communication between the user terminal 10 and the portal service system 1. In this particular case, the communication protocols from that having the highest priority to that having the lowest priority are “HTTP response”, “IMPP”, “SMTP”, “VoIP (Voice over IP)” and “HTTP (display at the time of next HTTP access)”. The selecting conditions indicate the conditions for selecting the communication protocol, as described above with reference to the step S42 shown in FIG. 3. The content selection indicates the communication protocol (or communication method) which determines the conversion which is to carried out with respect to the contents, as described above with reference to the step S43 shown in FIG. 3.

FIG. 6 is a diagram showing the service profile 6. The service profile 6 includes a plurality of lists of related services, including a list of moving services. The list of moving services includes a telephone number changing procedure, a driver's license renewing procedure, a credit card address changing procedure, a resident registration changing procedure and the like.

The lists of related services which are displayed at the user terminal 10 when the user connects the user terminal 10 to the portal service system 1 are of course not limited to the list of moving services. The list of moving services includes services which become required when the user moves.

The telephone number changing procedure (service) changes an old telephone number of the user to a new telephone number at the new address of the user. When the telephone number changing procedure is selected, a connection is made to the corresponding service system 9 of the telephone company, to notify information related to the old and new addresses of the user. Then, three candidate telephone numbers are displayed at the user terminal 10, for example, and the telephone number changing procedure is completed when the portal service system 1 makes an inquiry to the user terminal 10 and notifies the new telephone number selected by the user to the service system 9 of the telephone company.

The driver's license renewing procedure (service) changes the old address of the user registered for the driver's license to the new address of the user by suitable processes which may be similar to those carried out by the telephone number changing procedure.

The credit card address changing procedure (service) changes the old address of the user registered for the credit card to the new address of the user by suitable processes which may be similar to those carried out by the telephone number changing procedure.

The resident registration changing procedure (service) changes the old address of the user in the resident registration to the new address of the user by suitable processes which may be similar to those carried out by the telephone number changing procedure.

FIG. 7 is a diagram showing the content database 7. The content database 7 includes contents for a service Ser1, contents for a service Ser2, and the like. The contents for the service Ser1 include contents A for HTML, contents A for CHTML, contents A for Simple Text, contents B for HTML, contents B for CHTML, and contents B for Simple Text, as shown in FIG. 7.

In this particular case, the service Ser1, the service Ser2 and the like respectively correspond to the telephone number changing procedure (service), the driver's license renewing procedure, the credit card address changing procedure, the resident registration changing procedure and the like in the list of moving services of the service profile 6 shown in FIG. 6.

For example, in the contents for the service Ser1, that is, the telephone number changing procedure (service), the contents A for HTML include the following.

<html>

<body>

<h1> selection of new telephone number<h1>

. . .

Please select the new telephone number from the following numbers.<h1>

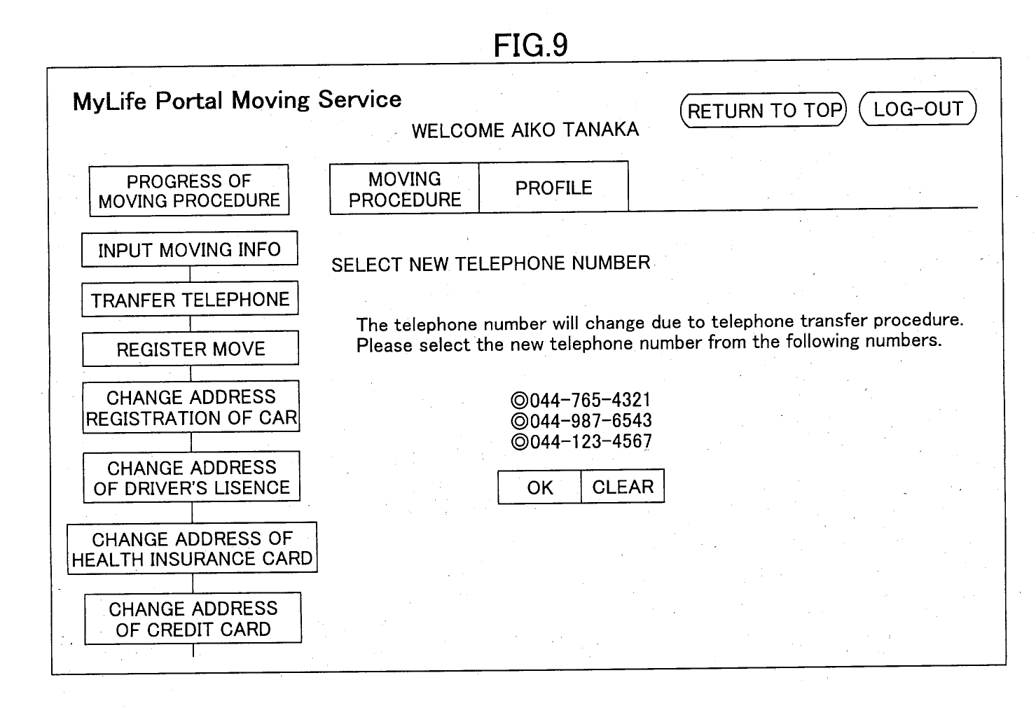

When the above described contents A for HTML are downloaded and displayed as an inquiry message on the browser of the user terminal 10, a second display is made on a screen of the user terminal 10 as shown in FIG. 9 which will be described later.

In addition, in the contents for the service Ser1, that is, the telephone number changing procedure (service), the contents A for Simple Text include the following.

selection of new telephone number

. . .

Please select the new telephone number from the following numbers.

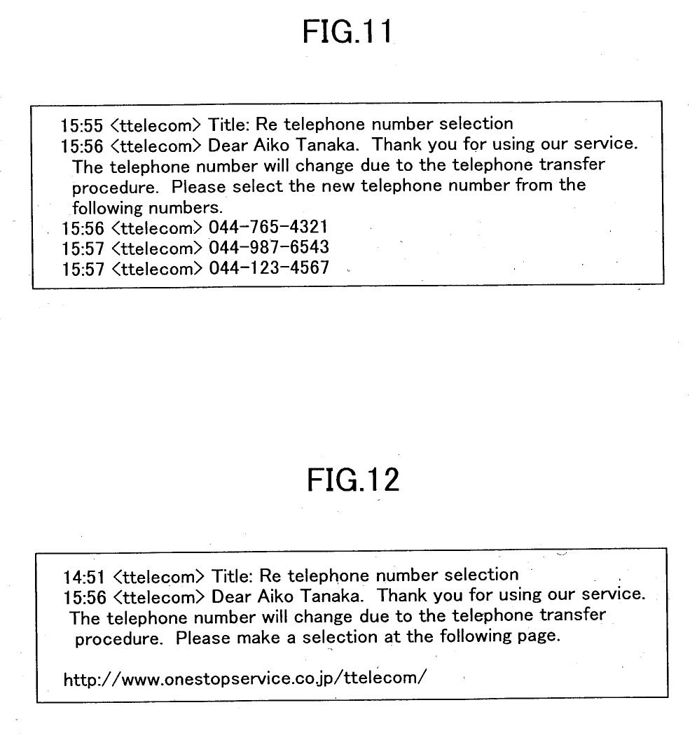

When the above described contents A for Simple Text are downloaded and displayed as an inquiry message on the browser of the user terminal 10, a fourth display is made on a screen of the user terminal 10 as shown in FIG. 11 which will be described later.

Therefore, by registering in the content database 7 contents corresponding to different communication methods (communication protocols) for each content, that is, each procedure (service), it is possible to automatically convert and send the message to suit an optimum communication method which is selected when the portal service system 1 makes an inquiry to the user terminal 10 by the selected optimum communication method, as described above in conjunction with the steps S10, S11, S14 and S15 shown in FIG. 2.

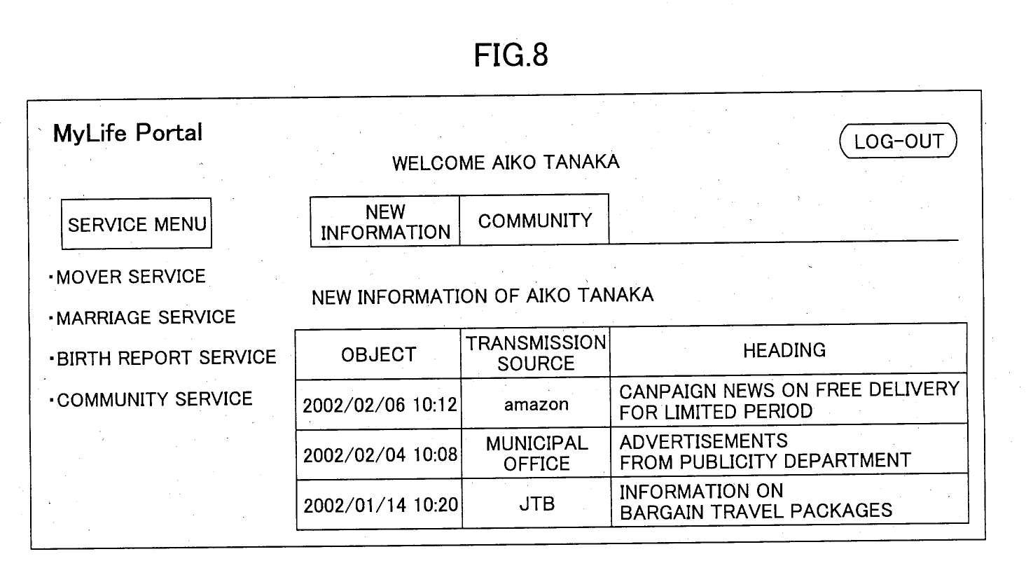

FIG. 8 is a diagram showing a first display on the screen of the user terminal 10. FIG. 8 shows the first display which is made after the user, “Aiko Tanaka”, makes a log-in to the portal service system 1 shown in FIG. 1. The first display includes new information (new arrivals) to the user “Aiko Tanaka” who made the log-in, and a service menu on a left portion. This service menu corresponds to the list of services displayed by the step S2 shown in FIG. 2. When the user “Aiko Tanaka” selects an arbitrary service, that is, the “moving service”, for example, from the service menu in the step S3 shown in FIG. 2, the lists of related services which are required when providing the moving service are searched in the service profile 6 shown in FIG. 6. The related services are extracted and collected in the step S4 shown in FIG. 2 by referring to the user profile 4 shown in FIG. 4 corresponding to the user “Aiko Tanaka”, so that the related services of the “moving service” can be provided.

FIG. 9 is a diagram showing the second display on the screen of the user terminal 10. FIG. 9 shows the second display which is made on the browser of the user terminal 10 of the user “Aiko Tanaka” as an inquiry message from the portal service system 1, when the user “Aiko Tanaka” selects the “moving service” on the first display shown in FIG. 8, and the telephone number of the user “Aiko Tanaka” is registered in the user profile 5 shown in FIG. 4 and the telephone number changes after the user “Aiko Tanaka” moves to the new address with respect to the “telephone number changing procedure” in the list of moving services of the service profile 6 shown in FIG. 6. The second display includes a left portion which indicates a progress of the various procedures which become necessary when the moving service of the service system 9 is selected. A procedure which is completed is displayed by changing color of the display or the like, so as to emphasize the completed procedure and make it easily recognizable to the user.

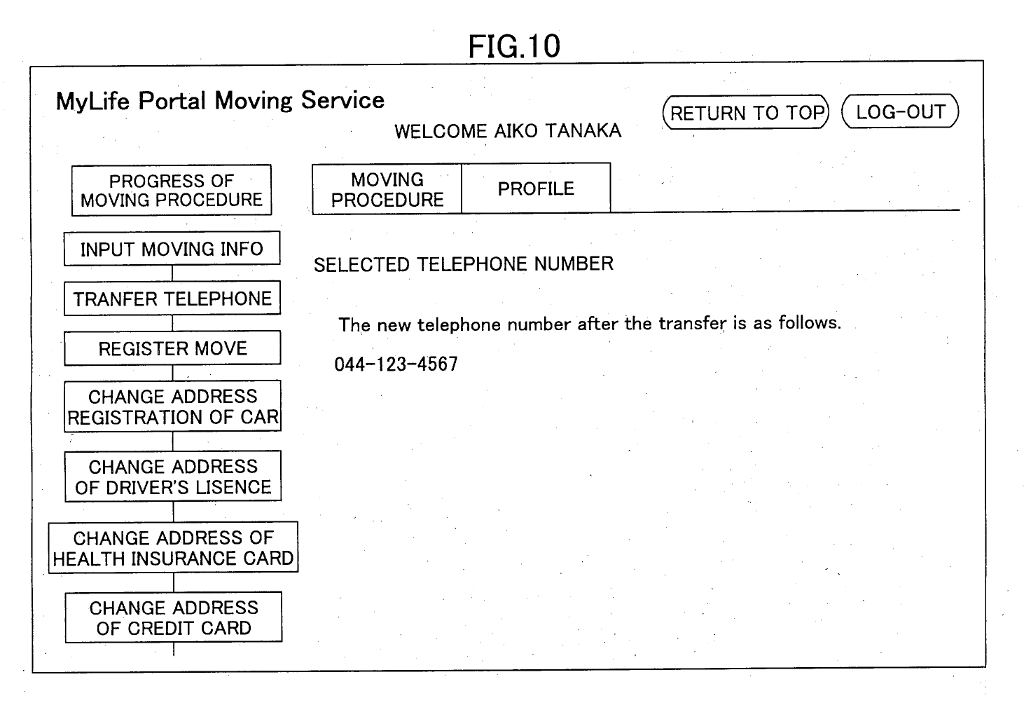

FIG. 10 is a diagram showing a third display on the screen of the user terminal 10. FIG. 10 shows the third display which is made on the browser of the user terminal 10 of the user “Aiko Tanaka” when this user response to the inquiry message from the portal service system 1 and selects the new telephone number from the three candidate telephone numbers indicated in the second display shown in FIG. 9. Hence, this third display notifies the user “Aiko Tanaka” that the new telephone number at the new address of this user is determined to the new telephone number selected by this user.

FIG. 11 is a diagram showing a fourth display on the screen of the user terminal 10. FIG. 11 shows the fourth display which is made on the browser of the user terminal 10 of the user “Aiko Tanaka” when the inquiry message is sent to the user terminal 10 from the portal service system 1. The fourth display shown in FIG. 11 thus corresponds to the second display shown in FIG. 9, but the fourth display is made in the text format.

FIG. 12 is a diagram showing a fifth display on the screen of the user terminal 10. FIG. 12 shows the fifth display which is made on the browser of the user terminal 10 of the user “Aiko Tanaka” when the notification is sent to the user terminal 10 from the portal service system 1. The fifth display shown in FIG. 12 thus corresponds to the third display shown in FIG. 10, but the fifth display is made in the text format.

Further, the present invention is not limited to these embodiments, but various variations and modifications may be made without departing from the scope of the present invention.

What is claimed is:

1. A portal site server system providing services of service systems to user terminals of users via at least one network, comprising:
a user profile registering at least communication methods to the users;
a communication priority table registering a priority order of the communication methods;
means for making an inquiry to a specific user by a communication method which has a highest priority and is selected from the communication methods registered in the user profile depending on the communication priority table, when a service request is received from the specific user and an inquiry to the specific user is required; and
means for updating the user profile based on information received from the specific user in response to the inquiry.

2. The portal site server system as claimed in claim 1, further comprising:
means for notifying user information which is related to the specific user and is registered in the user profile to one of the service systems in response to a request for the user information from said one of the service systems.

3. The portal site server system as claimed in claim 2, wherein:
said user profile registers inspecting permission information with respect to each user information, and further comprising:
means for making an inquiry to the specific user if no inspecting permission information is registered with respect to the user information related to the specific user in the user profile, and notifying the user information related to the specific user to said one of the service systems in response to a confirmation received from the specific user.

4. The portal site server system as claimed in claim 1, further comprising:
means for converting contents of the inquiry to the specific user according to the communication method which is selected when sending the inquiry to the specific user.

5. The portal site server system as claimed in claim 1, further comprising:
a service profile registering lists of related services; and
means for displaying the lists of related services registered in the service profile at a user terminal of the specific user, and requesting a service to one of the service systems which provides related services of one of the lists selected by the specific user.

6. A portal site method for providing services of service systems to user terminals of users via at least one network, comprising:
preparing a user profile which registers at least communication methods to the users, and a communication priority table which registers a priority order of the communication methods;
making an inquiry to a specific user by a communication method which has a highest priority and is selected from the communication methods registered in the user profile depending on the communication priority table, when a service request is received from the specific user and an inquiry to the specific user is required; and
updating the user profile based on information received from the specific user in response to the inquiry.

7. A computer-readable storage medium which stores a program for causing a computer to provide services of service systems to user terminals of users via at least one network, said program comprising:
a procedure causing the computer to prepare a user profile which registers at least communication methods to the users, and a communication priority table which registers a priority order of the communication methods;
a procedure causing the computer to make an inquiry to a specific user by a communication method which has a highest priority and is selected from the communication methods registered in the user profile depending on the communication priority table, when a service request is received from the specific user and an inquiry to the specific user is required; and
a procedure causing the computer to update the user profile based on information received from the specific user in response to the inquiry.

8. A portal site server system providing services of service systems to user terminals of users via at least one network, comprising:
a user profile registering at least communication methods to the users;
a communication priority table registering a priority order of the communication methods; and
a communication method selecting unit selecting one of the communication methods registered in the user profile and having a highest priority, according to the communication priority table, when a service request from a specific user is received and an inquiry to the specific user is required.

9. The portal site server system as claimed in claim 8, further comprising:
a lacking data acquiring unit making an inquiry to the specific user by the communication method selected by the communication method selecting unit, and updating the user profile based on information received from the specific user in response to the inquiry.

10. The portal site server system as claimed in claim 9, wherein said lacking data acquiring unit reads a user information, which is related to the specific user and is-requested from one of the service systems, from the user profile, and notifies the read user information to said one of the service systems, in response to a request for the user information from said one of the service systems.

11. The portal site server system as claimed in claim 10, wherein:
said user profile further registers inspecting permission information which indicates inspecting permission with respect to user information related to the users, and further comprising:
an inspecting permission confirmation unit making an inquiry to the specific user if no inspecting permission information is registered with respect to the user information related to the specific user in the user profile, and notifying the user information related to the specific user to said one of the service systems in response to a confirmation received from the specific user.

12. The portal site server system as claimed in claim 8, further comprising:
means for converting contents of the inquiry to the specific user according to the communication method which is selected when sending the inquiry to the specific user.

13. The portal site server system as claimed in claim 8, further comprising:
a service profile registering lists of related services; and
means for displaying the lists of related services registered in the service profile at a user terminal of the specific user, and requesting a service to one of the service systems which provides related services of one of the lists selected by the specific user.

14. The portal site server system as claimed in claim 8, wherein the communication methods are indicated by communication protocols.

15. The portal site server system as claimed in claim 14, wherein said communication method selecting unit selects one of the communication methods registered in the user profile and having a highest priority among the communication methods satisfying predetermined selecting conditions which indicate conditions for selecting a communication protocol.

16. A portal site method for providing services of service systems to user terminals of users via at least one network, comprising:
preparing a user profile registering at least communication methods to the users, and a communication priority table registering a priority order of the communication methods; and
selecting one of the communication methods registered in the user profile and having a highest priority, according to the communication priority table, when a service request from a specific user is received and an inquiry to the specific user is required.

17. The portal site method as claimed in claim 16, further comprising:
making an inquiry to the specific user by the communication method selected by the communication method selecting unit, and updating the user profile based on information received from the specific user in response to the inquiry.

18. The portal site method as claimed in claim 17, wherein said making the inquiry to the specific user includes:
reading a user information, which is related to the specific user and is requested from one of the service systems, from the user profile, and notifying the read user information to said one of the service systems, in response to a request for the user information from said one of the service systems.

19. The portal site method as claimed in claim 18, wherein:
said user profile further registers inspecting permission information which indicates inspecting permission with respect to user information related to the users, and further comprising:
making an inquiry to the specific user if no inspecting permission information is registered with respect to the user information related to the specific user in the user profile, and notifying the user information related to the specific user to said one of the service systems in response to a confirmation received from the specific user.

20. The portal site method as claimed in claim 16, wherein said one of the communication methods registered in the user profile and having the highest priority is selected from the communication methods satisfying predetermined selecting conditions which indicate conditions for selecting a communication protocol.

21. A computer-readable storage medium which stores a program for causing a computer to provide services of service systems to user terminals of users via at least one network, said program comprising:
a procedure causing the computer to prepare a user profile registering at least communication methods to the users, and a communication priority table registering a priority order of the communication methods; and
a procedure causing the computer to select one of the communication methods registered in the user profile and having a highest priority, according to the communication priority table, when a service request from a specific user is received and an inquiry to the specific user is required.

22. The computer-readable storage medium as claimed in claim 21, wherein said program further comprises:
a procedure causing the computer to make an inquiry to the specific user by the communication method selected by the communication method selecting unit, and to update the user profile based on information received from the specific user in response to the inquiry.

23. The computer-readable storage medium as claimed in claim 22, wherein said procedure causing the computer to make the inquiry to the specific user includes:
causing the computer to read a user information, which is related to the specific user and is requested from one of the service systems, from the user profile, and to notify the read user information to said one of the service systems, in response to a request for the user information from said one of the service systems.

24. The computer-readable storage medium as claimed in claim 23, wherein:
said user profile further registers inspecting permission information which indicates inspecting permission with respect to user information related to the users, and said program further comprises:
a procedure causing the computer to make an inquiry to the specific user if no inspecting permission information is registered with respect to the user information related to the specific user in the user profile, and to notify the user information related to the specific user to said one of the service systems in response to a confirmation received from the specific user.

25. The computer-readable storage medium as claimed in claim 21, wherein said procedure causing the computer to select one of the communication methods registered in the user profile and having the highest priority causes the computer to select said one of the communication methods from the communication methods satisfying predetermined selecting conditions which indicate conditions for selecting a communication protocol.
